(19) United States
(12) Patent Application Publication
(10) Pub. No.: US 2003/0128390 A1
(43) Pub. Date: Jul. 10, 2003

(54) System and method for simplified printing of digitally captured images using scalable vector graphics

(76) Inventors: Thomas W. Yip, Fort Collins, CO (US); K. Douglas Gennetten, Fort Collins, CO (US); Beth M.P. Delaney, Loveland, CA (US)

Correspondence Address: HEWLETT-PACKARD COMPANY, Intellectual Property Administration, P.O. Box 272400, Fort Collins, CO, 80527-2400, US

(21) Appl. No.: 10/039,100

(22) Filed: Jan. 4, 2002

(51) Int. Cl. G06K 1/00; G06F 15/00

(52) U.S. Cl. 358/1.18

(57) ABSTRACT

A scalable vector graphics (SVG) page layout logic receives a specification of a plurality of images, receives a specification for a page layout format, positions the specified number of images on a page and displays the page on a display.

### BACKGROUND OF THE INVENTION

1. Field of the Invention

The present invention generally relates to processing and printing digital images captured by a digital image capture device and, in particular, to a system and method for enabling automatic print page layout and/or album page layout of captured images, and the subsequent printing of the images, using a single application that employs a scalable vector graphics (SVG) format.

2. Related Art

With the advent of digitally based image capturing devices capable of “photographing” an image and providing the image in a digital data format, a digital “photograph” of the image is stored in a memory residing within or coupled to the image capturing device. A nonlimiting example of a digital image capturing device is the digital camera that captures still images and/or video images.

Many image capturing devices format digital data of the captured images using formats such as, but not limited to, tagged image file (TIF), joint photographics experts group (JPEG), graphic interchange format (GIF), moving picture experts group (MPEG) or other similar based digital image data formats. Such formats model the image as a plurality of pixels. One limitation of these pixel based data formats is that the scaling of the images, at some point, may result in a degradation of image quality as the individual pixels become visible. Furthermore, it is often computationally complex to rotate, skew or otherwise process digital image data.

Image processing applications are configured to receive digital image data for processing and/or printing. For example, the digital image data may be retrieved from a memory and subsequently processed. Such processing may include, but is not limited to, sizing, rotating, skewing and/or cropping the image. Eventually, a person processing the images may desire to print the image onto a paper medium using a printing device.

Such a process of retrieving images, processing images and then printing images is cumbersome in that an amount of time is required to perform the above described steps. Furthermore, another separate step of laying out images on a printed page may be required.

If the applications are separate, the person may have to buy the separate applications and learn to operate each of the separate applications. If a single application is used that performs the necessary multiple steps, the application may be a very expensive and/or complex. Furthermore, the person must have sufficient technical knowledge and expertise to understand the entire process, from transferring the image from the digital image capture device through the final printing of the image, and how to execute the associated applications. Thus, such a time consuming and technically complicated process is undesirable for a photographer who is not computer literate and/or who is used to taking photographs with a film based camera and dropping off the film at the processing center (or other convenient location) for later retrieval of the finished printed photographs.

### SUMMARY OF THE INVENTION

The present invention overcomes the inadequacies and deficiencies of the prior art as discussed hereinabove. The present invention, the scalable vector graphics (SVG) page layout logic, can be viewed receiving a specification of a plurality of images, receiving a specification for a page layout format, positioning the specified number of images on a page and displaying the page on a display. One embodiment uses a SVG format to position the specified number of images on the page.

### BRIEF DESCRIPTION OF THE DRAWINGS

The elements of the drawings are not necessarily to scale relative to each other. Like reference numerals designate corresponding parts throughout the several views.

FIG. 1 is a block diagram illustrating a digital image capture device in communication with a personal computer (PC).

FIG. 2 is a block diagram of the display of FIG. 1 illustrating four images selected for printing using a print page layout format by the scalable vector graphics (SVG) layout logic of FIG. 1.

FIG. 3 is a block diagram of the display of FIG. 1 illustrating four images selected for printing using a album page layout format by the scalable vector graphics (SVG) layout logic of FIG. 1.

FIG. 4 is a block diagram of the display of FIG. 1 illustrating two images selected for printing and formatted by the scalable vector graphics (SVG) layout logic of FIG. 1.

FIG. 5 is a flow chart illustrating the process employed by the SVG page layout logic of FIG. 1 for laying out images on a single page of paper.

### DETAILED DESCRIPTION

In general, the present invention relates to a system and method for enabling automatic print page and/or album page generation for captured images and the associated processing and printing using a single application, such as a web browser, that employs a scalable vector graphics (SVG) format.

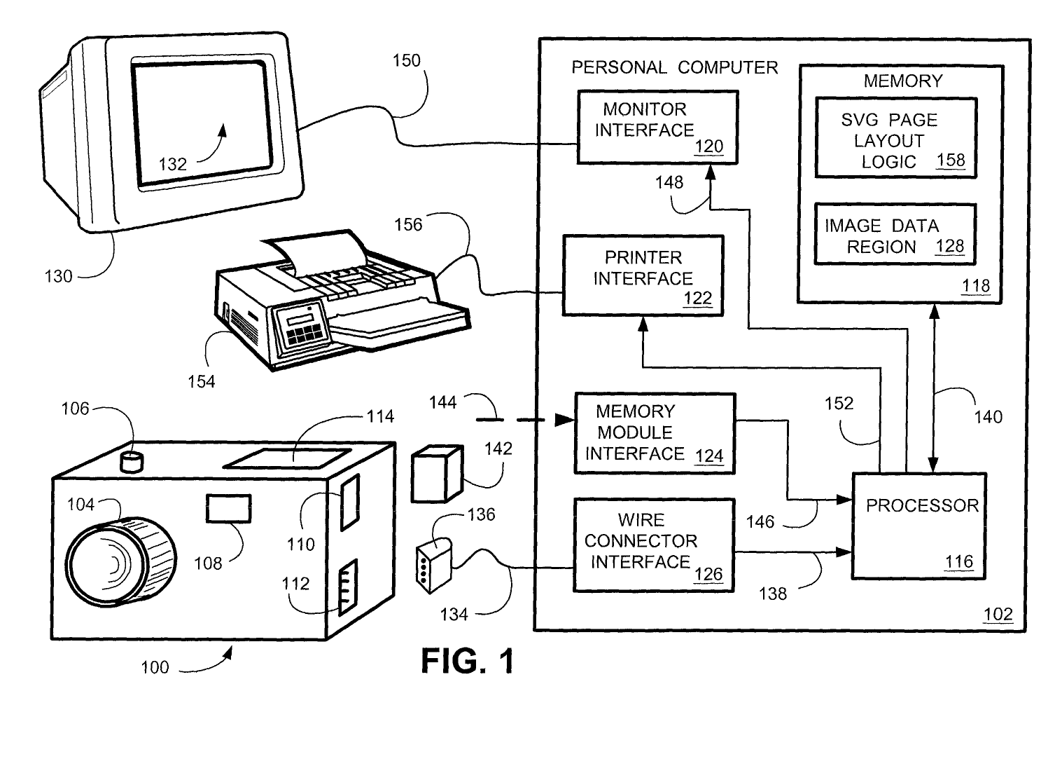

FIG. 1 is a is a block diagram illustrating an exemplary digital image capture device, a digital camera 100, in communication with a personal computer 102. The exemplary digital camera 100 further includes at least a lens unit 104, an image capture actuation button 106, a viewing lens 108, memory unit interface 110, and a display 114 and a plug-in interface unit 112. A display 114 is used for previewing images prior to capturing or for viewing captured images. For convenience of illustration, the display 114 is illustrated on the top of digital camera 100.

Lens unit 104 is a well-known device used for focusing the image on the photosensor. When the operator has focused the image to be captured and is satisfied with it, the operator actuates the image capture actuation button 106 to cause digital camera 100 to record a digital image, thus “photographing” the image. The operator of digital camera 100 may visually preview the image before capturing the image on display 114 and/or view the image directly through the viewing lens 108.

FIG. 1 further illustrates a personal computer 102 that is typically employed with digital cameras such that digital images captured by the digital camera may be retrieved, processed, printed and/or e-mailed. Personal computer 102 includes at least a processor 116, a memory 118, an monitor interface 120, a printer interface 122, a memory module interface 124 and a wire connector interface 126. Memory 118 further includes at least an image data region 128 where retrieved image data from the digital camera 100 is stored.

Personal computer 102 is further illustrated as being coupled to a display monitor 130, via connection 150. The display monitor 130 includes a display 132 for viewing the captured images.

One embodiment of digital camera 100 may transfer captured images to personal computer 102 via a hard wire connection 134. Connection 134 is coupled to plug-in attachment 136. Plug-in attachment 136 is configured to mate with plug-in interface unit 112. The user of personal computer 102 and digital camera 100 simply mates the plug-in attachment 136 into plug-in interface 112, thereby establishing connectivity between digital camera 100 and personal computer 102. The user then instructs personal computer 102 and/or digital camera 100 to execute logic such that digital images are transferred from the digital camera 100 through the wire connector interface 126, through processor 116 via connection 138, and then into the image data region 128 of memory 118 via connection 140. Or, the user may directly access digital image data from digital camera 100 for further processing.

In another embodiment of digital camera 100, digital image data is stored in memory module unit 142. When capturing images with the digital camera 100, memory module unit 142 is coupled to digital camera 100 through the memory unit interface 110. Digital image data is transferred to personal computer 102 by removing the memory module unit 142 from the digital camera 100 and coupling memory module unit 142 to the memory module interface 124. Typically, a convenient coupling port or interface is provided on the surface of personal computer 102 such that memory module unit 142 is directly coupled to personal computer 102, as illustrated by the dashed line path 144. Once memory module unit 142 is coupled to memory module interface 124, digital image data is transferred through processor 116, via connection 146, and into image data region 128 of memory 118, via connection 140. Or, the user may directly access the digital image data from the memory module unit 142 for further processing.

When the user of personal computer 102 has accessed the digital image data corresponding to the images captured by digital camera 100, as described above, the user of personal computer 102 may process selected images and cause the images to be printed by executing the SVG page layout logic 158. For convenience of illustration, processor 116 is illustrated as being coupled to monitor interface 120 via connection 148 and to monitor 130 via connection 150. Similarly, processor 116 is illustrated as being coupled to a printer interface 122 via connection 152. Printer interface 122 is configured to provide coupling to printing device 154 via connection 156 that is coupled to personal computer 102 such that selected images that have been processed according to the SVG page layout logic 158 are printed.

For convenience, personal computer 102 is illustrated as having only selected components of interest. However, personal computer 102 includes additional internal components that are not illustrated in FIG. 1. These additional components not shown are well known in the art and are not described in detail herein other than to the extent necessary to understand the functionality and operation of the SVG printed page layout invention.

For convenience of illustration, display monitor 130 is illustrated as a cathode ray tube (CRT) monitor configured to set on a tabletop. Any other suitable display device may be employed equally well for display of page layouts prepared by the SVG page layout logic 158, described in greater detail below. Similarly, the printing device 154 is illustrated as a tabletop printing device. Any other suitable printing device may be employed equally well for the printing of the pages laid out by the SVG page layout logic 158, described in greater detail below.

The SVG page layout logic 158 is executed using a convenient platform application, such as, but not limited to, a web page browser. The user begins the process by instructing the personal computer 102 to begin execution of the SVG page layout logic 158 residing in memory 118 (FIG. 1). In one embodiment, the user has already coupled digital camera 100 to personal computer 102, via connection 134, or has already coupled the memory module unit 142 to the memory module interface 124 (FIG. 1). Alternatively, the user has preloaded data associated with the captured images into image data region 128 of memory 118 (FIG. 1).

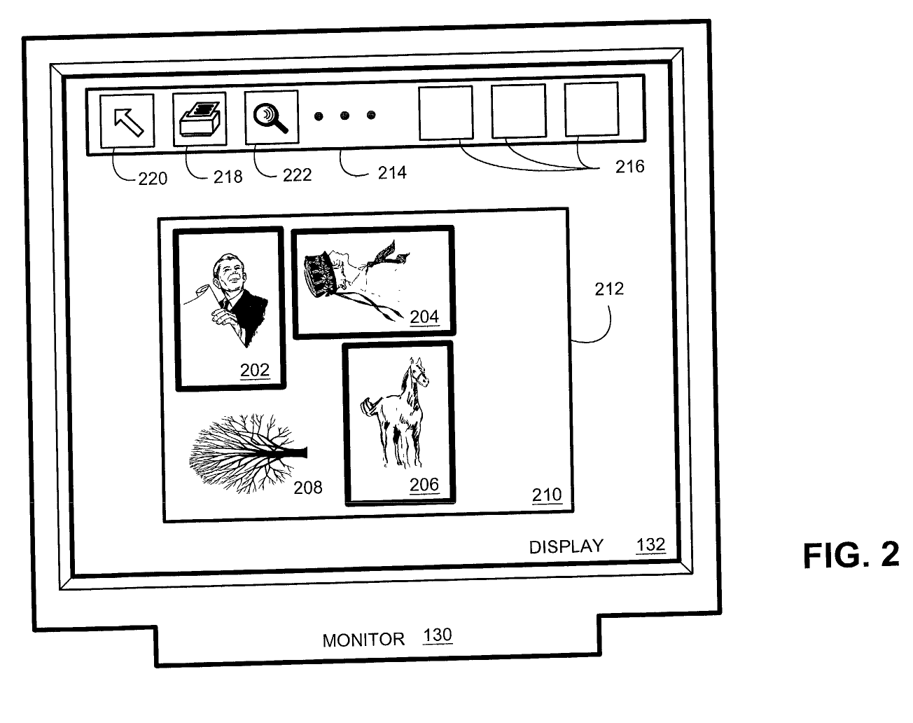

In one embodiment, the SVG page layout logic 158 causes personal computer 102 to query the user, in a suitable format, for the images that the user wishes to print on a page of paper. In accordance with the exemplary page 210 of FIG. 2, the user has specified four images 202, 204, 206 and 208. The SVG page layout logic 158 causes personal computer 102 to retrieve the image data associated with the four specified images 202, 204, 206 and 208. The image data is retrieved from a memory residing in the digital camera 100, from memory module unit 142, from image data region 128 or from another suitable storage medium, such as a digital video disk (DVD), a Zip™ drive memory, a hard drive memory or other data storage device based upon a predetermined location of image data.

When the user has specified the images to be processed, the SVG page layout logic 158 then determines the optimal position and maximum number of images that can be laid out on a page 210 using the print page layout format. For example, as illustrated in FIG. 2, the SVG page layout logic 158 has determined that four specified images 202, 204, 206 and 208 may be positioned onto page 210 as shown. Here, the SVG page layout logic 158 has positioned the image of a man 202 and an image of a horse 206 oriented in a vertical alignment with the display 132 (corresponding with a horizontal alignment with the page of paper), and has positioned the image of a woman 204 and an image of a tree 208 in horizontal alignment with the display 132 (corresponding to a vertical alignment with the page of paper). Thus, the SVG page layout logic 158 employs the position feature inherent in the SVG format to efficiently and effectively position and/or orient the images on a print page layout suitable for printing. This embodiment of the SVG page layout logic 158 is particularly suited for printing a maximum number of specified images on a single page of paper. If the number of images specified exceeds the maximum number of images that can be printed on a single page, the SVG page layout logic 158 formats the remaining specified images on another page(s).

Once the user is satisfied with the size and/or position of the specified images, the images can be printed. A print command then causes a printer to print the specified images 202, 204, 206 and 208 as laid out on page 210. For example, in one embodiment, when the user positions a cursor over the tool button 218 having a printer icon and actuates the tool button 218, the images 202, 204, 206 and 208, as positioned in accordance with page 210 and as shown on display 132, are printed on a single sheet of paper. Alternatively, the formatted page of images can be stored and later retrieved for processing, viewing and/or printing.

For convenience, one embodiment delineates the boundaries of page 210 with a border line 212. Border line 212 is of a suitable thickness and color such that a user understands that the four exemplary images 202, 204, 206 and 208 will be positioned on a printed page as indicated on page 210. Another embodiment may color and/or shade portions of display 132 not associated with one of the four exemplary images 202, 204, 206 and 208 with a suitable color to delineate page 210.

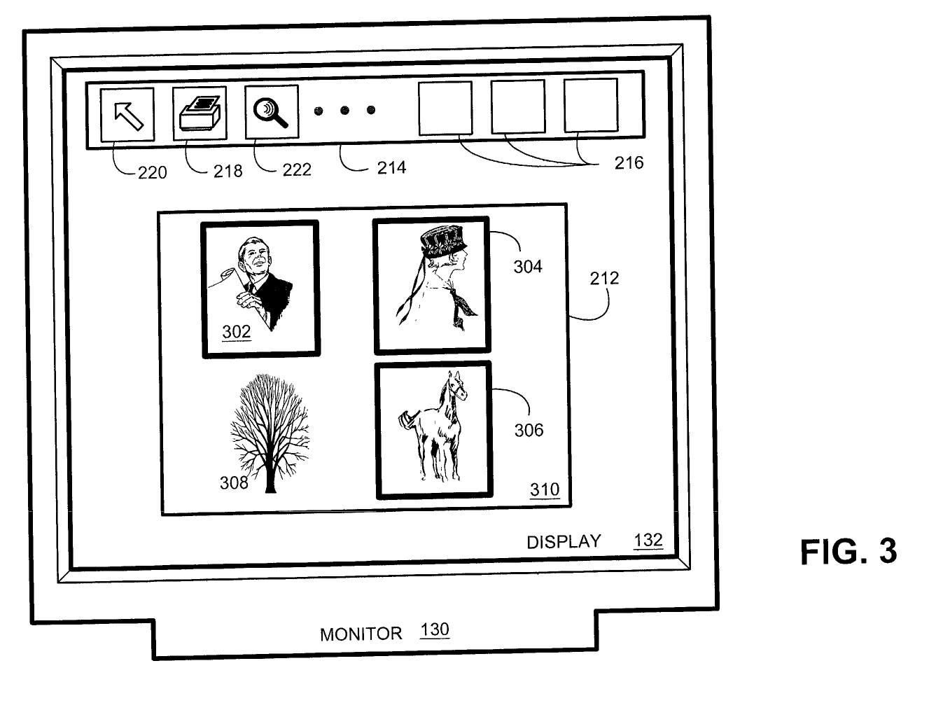

In another embodiment, the SVG page layout logic 158 (FIG. 1) causes personal computer 102 to query the user, in a suitable format, for the images and the position that the user wishes to print using an album page layout. FIG. 3 is a block diagram of the display of FIG. 1 illustrating four exemplary images 302, 304, 306 and 308 captured by digital camera 100 (FIG. 1) that have been selected for printing using an album page layout. The four exemplary images 302, 304, 306 and 308 are formatted, sized, positioned and/or oriented by the SVG page layout logic 158 (FIG. 1) onto page 310 so that the images may be printed on a single page of paper by the printer 154 (FIG. 1) in a visually pleasing format. Alternatively, the formatted page of images can be stored and later retrieved for processing, viewing and/or printing.

All of images 302, 304, 306 and 308 have a common orientation and size on the page 310, and are positioned on the page 310 using a portrait format. Alternatively, the images could be oriented using a landscape format. This embodiment of the SVG page layout logic 158 is particularly suited for printing a single page of images suitable for inserting directly into a photograph album or the like. Thus, the person does not have to spend time placing individual photograph into an album page photograph holder. Also, the user may not have to buy an album page photograph holder if the album is configured to clip in printed pages directly into the photograph album, such as a ring binder type photograph album. Thus, the SVG page layout logic 158 employs the position feature inherent in the SVG format to efficiently and effectively position and/or orient the images to create an album page layout.

One embodiment of the SVG page layout logic 158 automatically positions one or more specified images onto the page 310 using an aspect ratio determined by image capture device 100 (FIG. 1). Any number of images can be specified. The SVG page layout logic 158 uses the scaling feature inherent in the SVG format to efficiently and effectively size the images on an album page layout for printing.

In another embodiment, the user specifies a large number of images to be formatted. For example, but not limited to, a user specifies that twenty-one images are to be printed using an album page layout, landscape format. After identifying the specified images, the SVG page layout logic 158 automatically scales and positions the specified images into a matrix of images having seven images per row and three rows. Alternatively, the user may have specified a portrait format. The SVG page layout logic 158 would then automatically scale and position the images into a matrix of images having three images per row and seven rows. One skilled in the art will appreciate that the number of images that a user can specify for printing on a page, the orientation (either landscape or portrait), and the position of the images on the page (image matrix specifications), enable a nearly limitless variety of options for displaying images on a album page layout.

In another embodiment, when the specified images have differing aspect ratios, the SVG page layout logic 158 reformats the specified images, if necessary, into a predefined or standard aspect ratio so that all images appear on page 310 with the same aspect ratio. Thus, such an embodiment may be configured to resize an image and/or crop portions of an image using the scaling and croping features inherent in the SVG format.

In another embodiment, the user, in addition to specifying the images to be laid out on an album page layout, specifies the size of one or more images. Thus, one or more highly desirable images and a number of smaller thumbnail sized images may be sized and positioned on a single page of paper suitable for inserting into a photograph album after printing.

In yet another embodiment, the SVG page layout logic 158 uses the position feature inherent in the SVG format to efficiently and effectively position the images on a album page for printing in accordance with drag-and-drop instructions from the user. Here, the SVG page layout logic 158 automatically prepares a first draft of the album page. The user then repositions images on the page by simply dragging and dropping images into a desired position on the page. The SVG page layout logic 158 then, in one operating mode, automatically re-positions the other images. In another operating mode, the SVG page layout logic 158 allows the user to manually re-position a plurality of the images using a drag-and-drop feature. Other suitable manual positioning techniques could be equally employed.

In one embodiment, the SVG page layout logic 158 is configured to generate an album page layout using any specified album page size. Page 310 (FIG. 3) is illustrated as a standard eight and one-half by eleven inch album page in a landscape orientation. Other sizes of albums could be specified. For example, some photograph albums are configured for display areas of approximately five by seven inches. The SVG page layout logic 158 could lay out and print one or more images sized and positioned to fit on a five by seven inch page, or, be configured to lay out and print one or more images sized and positioned to fit on two five by seven inch pages such that a single sheet of eight and one-half by eleven inch sheet of paper is used for printing both pages.

In the above described embodiments, a completed album page layout is displayed on the display using web browser or the like so that the user can visually inspect the page(s). Thus, the SVG page layout logic 158 employs the SVG format to efficiently and effectively display the images on an album page layout that will be printed. Once the user is satisfied with the size and/or position of the specified images, the images can be printed. A print command then prompts a printer to print the specified images 302, 304, 306 and 308 as laid out on page 310. For example, when the user positions a cursor (not shown) over tool button 218 having a printer icon and actuates tool button 218, the images 302, 304, 306 and 308, as positioned in accordance with page 310 and as shown on display 132, are printed on a single sheet of paper.

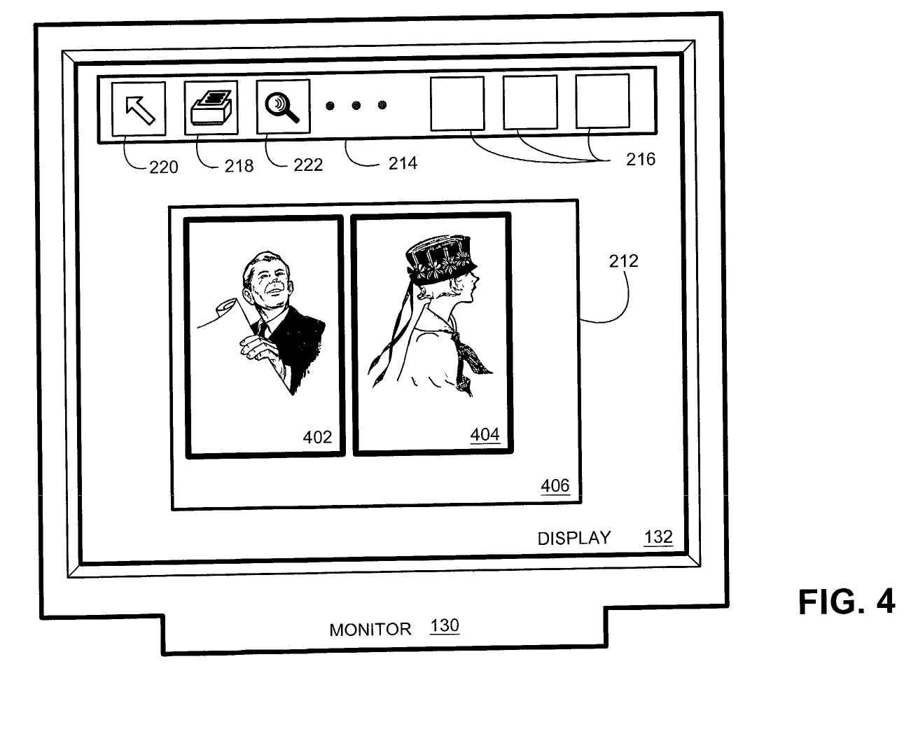

In another embodiment, the SVG page layout logic 158 causes personal computer 102 to query the user, in a suitable format, the size of the specified image(s) that the user wishes to have printed on a page of paper. FIG. 4 is a block diagram of the display of FIG. 1 illustrating two images 402 and 404 sized and positioned by the SVG page layout logic 158 (FIG. 1). The user has responded to a query requesting the size of the specified images. In the exemplary print page layout of FIG. 2, the user has specified image sizes such that two images are printed on a single page of paper. Thus, SVG page layout logic 158 has determined the optimal sizing and position of two images 402 and 404. Here, the SVG page layout logic 158 has positioned the image of a man 302 and an image of a woman 304 in a vertical alignment on page 406 (corresponding to a page of paper oriented in a landscape format).

The above described embodiment of the SVG page layout logic 158 is particularly suited for printing a specified number of images on a single page of paper. For example, if the user had specified three images, the SVG page layout logic 158 would determine the optimal size and position for the printing of three images. Individual images may be specified, multiple copies of the same image may be specified, or multiple copies of different images may be specified by the person processing the images. A print page layout or an album page layout format may be specified. Thus, the SVG page layout logic 158 employs the scaling feature and the position feature inherent in the SVG format to efficiently and effectively scale and position the specified images having a specified size. This embodiment is particularly suited for printing, for example, a number of wallet size images of a selected image for sharing with other people.

An alternative embodiment of the SVG page layout logic 158 allows the user to specify multiple pages of the page 210, 310 and/or 410 (FIGS. 2-4) that will be printed. For example, the user may desire two printed pages of the same images. The SVG page layout logic 158 then prepares a print or album page layout and initiates printing of the specified number of pages. This embodiment is particularly suited for printing, for example, a number of pages of selected images for sharing with other people.

An alternative embodiment of the SVG page layout logic 158 allows the user to specify different sizes of individual images that are to be printed. This alternative embodiment allows the user to specify a plurality of individual images of interest and then to specify a desired size for each selected image. Once the specification by the user has been completed, the SVG page layout logic 158 determines the optimal position of the selected images on one or more sheets of paper such that the total number of printed pages are minimized. For example, the user may desire a standard five inch by seven inch print of a first specified image and a second specified image, and wallet size prints of a specified third and fourth image. Furthermore, the user may specify that three copies of the fourth selected image are to be printed. Thus, the SVG page layout logic 158 configures the position of a plurality of images on a plurality of pages of printed paper such that the fewest number of printed pages are required to print the specified images. This embodiment is particularly suited for printing, for example, a number of wallet size images and a number of standard frame size images of a selected image for sharing with other people.

The user may specify any image size. However, it is frequently desirable to use standard photograph sizes. For example, the user may specify a standard three inch by five inch size. Or the user may specify a wallet size picture. Furthermore, in one embodiment, a listing of standardized image sizes is provided to the user so that the user may more conveniently specify a desired image size. Such standardized images include, but are not limited to three inches by five inches; four inches by six inches; five inches by seven inches; eight inches by ten inches; eleven inches by fourteen inches; and full frame. Here, the SVG page layout logic 158 is configured to position the images to optimize to placement of the images on a single page of paper.

The above described embodiments of the SVG page layout logic 158 retrieves a plurality of images and/or positions the images for printing on a single page of paper. In some instances, the number of images (and size of the images) may be specified such that not all of the specified images can be positioned onto a single page or sheet using the print page layout or the album page layout. Here, the SVG page layout logic 158 prepares a first page or sheet. Then, remaining specified images are laid out on subsequent pages. Thus, if all images are desired to be printed, the user indicates so to the SVG page layout logic 158. The SVG page layout logic 158 causes images to be retrieved until the maximum number of images per page is reached, and then positions those images onto a first page. Then, additional images are retrieved until the maximum number of images per page is reached, and then positions those images onto a second page. The above process is continued until all the desired images are retrieved.

Or, images may be laid out from the earliest to the latest, or from the latest to the earliest. Alternatively, the user may define the order that the specified images are laid out.

An alternative embodiment of the SVG page layout logic 158 allows the user to change or re-define the specification of images that are to be printed. This alternative embodiment allows the user to preview the initially specified images, or all of the images in specified location such as a memory, and then select desired images for further processing and/or printing. One embodiment displays a plurality of thumbnails of the images on a single page. The user identifies desired images, and then uses tool button 220 (FIGS. 2 and 3) or another suitable selection method to select the desired images. Alternatively, the user could select images that are to be discarded, deleted or otherwise identified as undesirable images, thus leaving desirable images.

Furthermore, a magnifying tool button 222 (FIGS. 2 and 3) may be used to preview a larger version of the selected image. The selected image is magnified and displayed on the display 132 using the scaling feature inherent in the SVG format. After a plurality of desired images are selected, and or their size specified, the SVG page layout logic 158 optimally positions the plurality of images on a suitable number of pages.

The above described embodiment allowing the user to select a plurality of desired images may further include the feature of allowing the user to specify the order in which the images will be positioned onto the pages. Such a feature would be desirable in instances where the user desires to time sequence the plurality of selected images. Images may be ordered based upon meta data associated with an image, such as a time stamp. Or, the user may assign a tag, such as a number or letter designating image order, to selected images such that the SVG page layout logic 158 automatically reorders the selected images in the specified order. Or, images may be laid out based upon the time and date that the image was captured. For example, but not limited to, images may be laid out from the earliest to the latest, or from the latest to the earliest. Alternatively, the user may define the order that the specified images are laid out.

The above described embodiments of the SVG page layout logic 158 are described as being included as part of a web browser. Such an embodiment is easily implemented by adapting a browser or by attaching suitable code modules to a browser. Such an embodiment is particularly desirable when the user is already familiar with the web browser, thereby minimizing the number of new program commands that the user must learn to operate the SVG page layout logic 158.

An alternative embodiment of the SVG page layout logic 158 is implemented in other types of applications. For example, the SVG page layout logic 158 may be configured to be incorporated into an image processing application.

Yet another embodiment SVG page layout logic 158 may be implemented in a stand-alone application. Such an embodiment is particularly desirable in providing consumers a stand-alone product that does not require purchase of another product that the SVG page layout invention has been incorporated into.

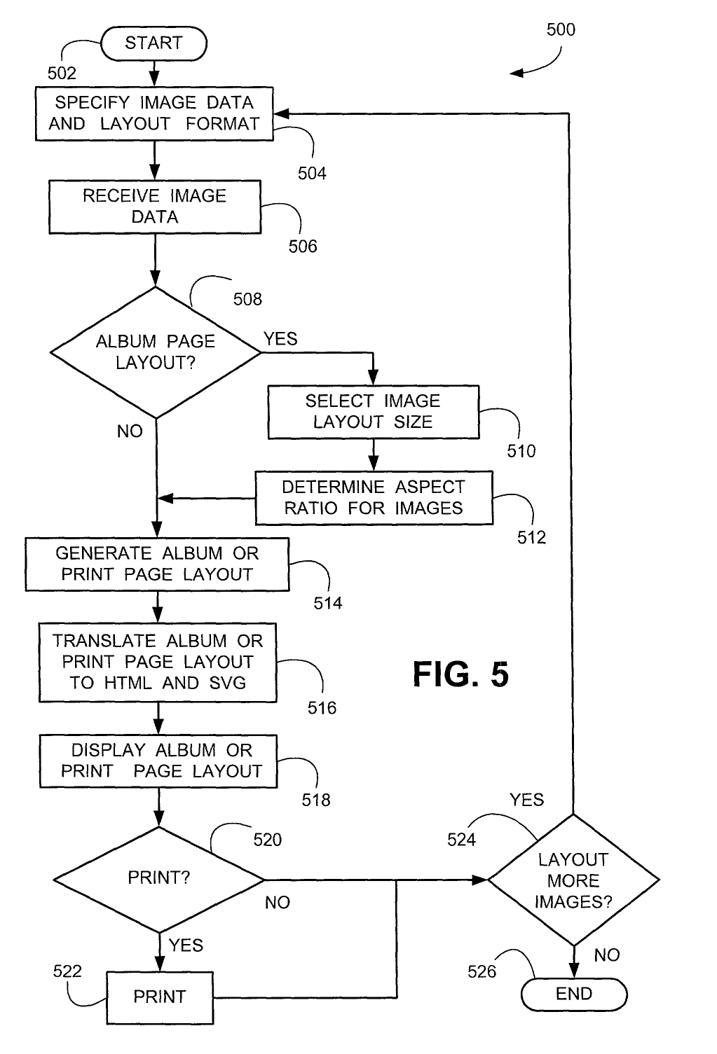

FIG. 5 is a flow chart 500 illustrating the process employed by the SVG page layout logic 158 (FIG. 1) for laying out images on a single page of paper. The flow chart 500 shows the architecture, functionality and operation of one implementation of the software for implementing the SVG page layout logic 158. In this regard, each block may represent a module, segment or portion of code, which comprises one or more executable instructions for implementing the specified logical function(s). It should also be noted that in some alternative implementations, the functions noted in the blocks may occur out of the order noted in FIG. 5 or may include additional functions without departing from the functionality of the SVG page layout logic 158. For example, two blocks shown in succession in FIG. 5 may be in fact be executed substantially concurrently, the blocks may be sometimes executed in the reverse order, or some of the blocks may not be executed in all instances, depending upon the functionality involved, as will be further clarified below. All such modifications and variations are intended to be included within the scope of this disclosure and to be protected by the accompanying claims.

The process illustrated by flow chart 500 begins at block 502. At block 504, the user specifies the image data and the layout format. For example, the user may specify one or more individual images that are to be processed. Also, the user specifies a print page layout format or an album page layout format.

At block 506, the specified image data is received. At block 508 a determination is made whether an print page layout is desired. If an album page layout is desired (the YES condition), the process proceeds to block 510. At block 510, in one embodiment, the SVG page layout logic 158 selects the image layout size. At block 512, the aspect ratio for the selected images is determined based upon the received image data. The process then proceeds to block 514.

If at block 508 an album page layout is not desired (the NO condition), the process proceeds to block 514. That is, the user desires a print page layout at block 508 if the NO condition is selected.

At block 514, the SVG page layout logic 158 generates a layout of the images in the specified album page layout or the print page layout specified at block 504. At block 516, the images are translated into the album or print page layout to a hypertext markup language (HTML) and SVG format. At block 518, the album page or print page layout is displayed to the user.

At block 520, a determination is made whether the user desires to print the displayed layout. If so (the YES condition), the displayed layout is printed at block 522. The process then proceeds to block 524. If the user does not desire to print the displayed layout (the NO condition), the process proceeds to block 524.

At block 524, a determination is made whether or not more images are to be laid out. If not (the NO condition), the process proceeds to block 526 and ends. If more images are to be laid out at block 524 (the YES condition), in one embodiment, the process proceeds back to block 504 where the user specifies new image data and a new layout format. Additional images are then processed by the SVG page layout logic 158 as described above.

In an alternative embodiment, if more images are to be laid out at block 524 (the YES condition), the process proceeds directly back to 506 to process those images specified by the user but have not yet been processed by the SVG page layout logic 158. For example, the user may have specified a sufficient number of images, and may have specified image sizes, such that only a portion of the specified images can be laid out on a single page. Thus, this embodiment processes a first portion of images and then processes the remaining images.

The above described embodiment of the SVG page layout logic 158 (FIG. 1) operating in accordance with the process illustrated in FIG. 5 is configured to size and/or orient the plurality of images residing in the identified memory. Thus, all images in the memory are processed. If the user does not want all images to be processed by the SVG printed page layout invention, the user selects the desired images that are to be processed by the SVG page layout logic 158, and either deletes data associated with undesirable images or saves desirable images into a file, before executing the SVG page layout logic 158 (FIG. 1). Such an embodiment is desirable when the user prefers to use other methods of selecting images for printing.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Now, therefore, the following is claimed:

1. A system for processing digital images, comprising:
means for specifying a plurality of images;
means for specifying a page layout format;
means for retrieving the plurality of images;
means for positioning the plurality of images on a page; and
means for displaying the page on a display using a scalable vector graphics (SVG) format.

2. The system of claim 1, wherein the means for positioning is implemented by a processor, and wherein the means for retrieving retrieves the specified images from a memory.

3. A method for processing digital images, the method comprising the steps of:
receiving a specification of a plurality of images;
receiving a specification for a page layout format;
positioning the specified number of images on a print page; and
displaying the print page on a display.

4. The method of claim 3, wherein the step of positioning the specified number of images on the print page further comprises the step of using a scalable vector graphics (SVG) format.

5. The method of claim 3, wherein the step of receiving the specification for the page layout format further comprises the step of receiving a specification for an album page layout.

6. The method of claim 5, further comprising the steps of:
selecting an album page aspect ratio;
comparing an aspect ratio of each one of the specified plurality of images to the album page aspect ratio; and
modifying the aspect ratio of each one of the specified plurality of images to equal the album page aspect ratio when the aspect ratio of each one of the specified plurality of images does not equal the album page aspect ratio.

7. The method of claim 3, further comprising the step of receiving a specified orientation such that the print page is oriented according to the specified orientation.

8. The method of claim 7, wherein the step of receiving the specified orientation further comprises the step of receiving a specification for a landscape orientation.

9. The method of claim 7, wherein the step of receiving the specified orientation further comprises the step of receiving a specification for a portrait orientation.

10. The method of claim 3, wherein the step of receiving the specification for the page layout format further comprises the step of receiving a specification for a print page layout.

11. The method of claim 3, further comprising the steps of:
determining a maximum number of images that will fit on the print page, the maximum number of images being less than the total number of the plurality of images;
selecting a number of images from the plurality of images specified, the selected number of images equal to the maximum number of images;
positioning the selected number of images on the print page using a scalable vector graphics (SVG) format; and
displaying the page on the display.

12. The method of claim 11, further comprising the steps of:
selecting a second number of images from the plurality of images specified, the selected second number of images equal to the maximum number of images;
positioning the selected second number of images on a second print page using the SVG format; and
displaying the second print page on the display.

13. A computer readable medium for processing digital images, the program comprising logic configured to perform the steps of:
receiving a specification of a plurality of images;
receiving a specification for a page layout format;
retrieving the specified plurality of images from a memory; and
positioning the specified number of images on a page using a scalable vector graphics (SVG) format.

14. The computer readable medium of claim 13, wherein the logic configured to receive the specification for the page layout format further comprises logic configured to perform the step of receiving a specification for an album page layout.

15. The computer readable medium of claim 14, further comprising logic configured to perform the steps of:
selecting an album page aspect ratio;
comparing an aspect ratio of each one of the specified plurality of images to the album page aspect ratio; and
modifying the aspect ratio of each one of the specified plurality of images to equal the album page aspect ratio when the aspect ratio of each one of the specified plurality of images does not equal the album page aspect ratio.

16. The computer readable medium of claim 13, further comprising logic configured to perform the step of receiving a specified landscape orientation such that the page is oriented according to the landscape orientation.

17. The computer readable medium of claim 13, further comprising logic configured to perform the step of receiving a specified portrait orientation such that the page is oriented according to the portrait orientation.

18. The computer readable medium of claim 13, wherein the logic configured to receive the specification for the page layout format further comprises logic configured to perform the step of receiving a specification for a print page layout.

19. The computer readable medium of claim 13, further comprising logic configured to perform the steps of:
determining a maximum number of images that will fit on the page, the maximum number of images being less than the total number of the plurality of images;
selecting a number of images from the plurality of images specified, the selected number of images equal to the maximum number of images;
positioning the selected number of images on the page using the SVG format; and
displaying the page on a display.

20. The computer readable medium of claim 19, further comprising logic configured to perform the steps of:
selecting a second number of images from the plurality of images specified, the selected second number of images equal to the maximum number of images; and
positioning the selected second number of images on a second page using the SVG format.
